(19) United States
(12) Patent Application Publication
(10) Pub. No.: US 2012/0005464 A1
(43) Pub. Date: Jan. 5, 2012

(54) START UP PROCESSING METHOD, INFORMATION PROCESSING APPARATUS, AND COMPUTER-READABLE STORAGE MEDIUM STORING PROGRAM

(75) Inventor: Noriyoshi TANAKA, Kahoku (JP)

(73) Assignee: Fujitsu Limited, Kawasaki (JP)

(21) Appl. No.: 13/074,502

(22) Filed: Mar. 29, 2011

(30) Foreign Application Priority Data
Jul. 5, 2010 (JP) 2010-153190

(51) Int. Cl. G06F 9/24

(52) U.S. Cl. 713/1

(57) ABSTRACT

A method includes loading a first module including first shared information commonly used by two or more of the plurality of modules; store access information for accessing the first shared information to a storage areas; load a second module including interface information for accessing the access information; and accessing the access information by the second module using the interface information and obtaining the first shared information via the access information, thereby, the size of a program related to the startup processing of the information processing apparatus can be reduced, and information can be shared among phases during the startup processing.

### CROSS-REFFERENCE TO RELATED APPLICATION

This application is based upon and claims the benefit of priority of the prior Japanese Patent Application No. 2010-153190, filed on Jul. 5, 2010, the entire contents of which are incorporated herein by reference.

### FIELD

The embodiments discussed herein are related to a technique for performing startup processing of an information processing apparatus.

### BACKGROUND

In recent years, techniques have been widely recognized, in which an extensible firmware interface (EFI) is used instead of a basic input/output system (BIOS) for startup processing of a personal computer (PC) (see Patent Document 1 and Non-Patent Document 1). An EFI is platform firmware replacing a BIOS, and makes hardware of an PC to prepare for reading the operating system (OS). Integrating an EFI into a motherboard of a PC can shorten the startup time of the PC, as well as simplifying hardware design and facilitating software development. The efforts to standardize EFI BIOSs have been made by the Unified EFI Forum.

An EFI has main phases until the OS starts up, namely, the SEC (Security), PEI (Pre-EFI Initialization), DXE (Driver Execution Environment), and BDS (Boot Device Selection) phases, which are processed in the order of SEC, PEI, DXE, and BDS.

Each phase is made up of multiple modules, referred to as PEI modules (PEIMs). The modules of the DXE phase include a DXE driver and an EFI driver.

After the respective modules are read from the BIOS flash and expanded (loaded) to execution areas, such as a CPU (Central Processing Unit) cache or a memory, they are executed in the condition when each module becomes ready to be executed (this condition is referred to as a protocol in the EFI). Note that the area to which modules in the CPU cache is loaded is referred to as a CAR (Cache As Ram) area.

FIG. 26 is a diagram illustrating each phase of the EFI, indicating a program load operation area, a CPU mode, and a development language for each phase (EFI Phase). In addition, FIG. 27 is a diagram illustrating the module configuration in a conventional EFI; and FIG. 28 is a diagram schematically illustrating a program load area for each phase in the EFI.

In the EFI, as depicted in FIG. 26, the CPU operation modes are different for different EFI phases, including the 16-bit, 32-bit, 64-bit, 32-bit System Management Modes (SMMs) and the 64-bit SMM modes. In addition, as depicted in FIG. 26 to FIG. 28, in the EFI, areas in which a program of the module is loaded and the program is executed (program load operation areas) are different for different EFI phases. Note that such program load execution areas include a BIOS flash, a CAR, and a memory (including the SMM), as depicted in FIG. 26.

In the startup processing of a PC in accordance with the conventional EFI, a program is load in a BIOS flash and the function of the CAR is enabled. In other words, in the SEC phase, the program is loaded in the BIOS flash, as depicted in FIG. 27.

Then, in the PEI phase, the program is load in this CAR area, and initialization of the memory controller is executed in this PEI. After memory accesses are enabled, the program is loaded in the memory. In other words, in the PEI phase, after the program is loaded in the CAR area, the program is loaded in the memory, in the initial stage of the PEI phase.

Thereafter, in the later stage of the PEI, the setting of the chip set is performed, thereby performing the minimal chip set setting and the like for executing the DXE. In the DXE phase, after the program is loaded in a memory, the BDS is read.

Different program languages are used in different phases, and an assembler language is used in the SEC while the C language is mainly used in the PEI, DXE, and BDS, as depicted in FIG. 26.

In such a conventional EFI, functions that are commonly required for everymodule, such as screen display or keyboard entries, are included in a library, and such shared function libraries are added to the respective modules.

More specifically, as depicted in FIG. 27, in the conventional EFI, shared feature libraries are added to each of the PEI and DXE (BDS) modules.

In addition, in the conventional EFI, use of a HOB (Hand Of Block) structure is known for sharing information, such as the memory size and the type of the CPU, in different phases.

Specifically, information, known as a HOB structure, created in the PEI phase, is passed to the DXE phase, via the memory, thereby achieving information sharing between the PEI phase and the DXE phase.

Patent Reference 1: Japanese Laid-open Patent Publication No. 2008-102906

Non-Patent Document 1: Vincent Zimmer, “Introducing the Intel Platform Innovation Framework for the Extensible Firmware Interface”, February, 2004, http://www.deviceforge.com/articles/AT8747644820.html

However, in such a conventional EFI, since each module has its own shared function library, the size of the module is increased with increased size of the shared function library. As a result, greater volume of resources is consumed by the EFI. For example, in server and embedded systems, a greater number of RAS (Reliability, Availability and Serviceability) functions are required, and accordingly, the size of the shared function library is increased. Thus, the size of the resources tends to be increased in server and embedded systems.

In other words, since each module includes a respective shared function library in the conventional EFI, the size of the module is increased, which results in increasing sizes of the area in the BIOS flash for storing the EFI and the program load operation area used by the EFI.

In addition, in the technique for information sharing between the phases in the conventional EFI, a reference to a HOB structured cannot be made until the module for operating the DXE phase (called “DXE core”) becomes ready during switching the phase from the PEI to the DXE, such as switching of the CPU mode from the 32-bit mode to the 64-bit mode.

For example, there may be some cases in which information sharing between the PEI and DXE phases is required when a hard error is detected and the memory structure is required to be checked. However, the information sharing cannot be performed until the DXE core is ready as described above, which causes delay of the processing.

In addition, since the addresses of the locations in which the shared function library is expanded are varied in different modules, the information of the shared function library cannot be shared between the modules. Accordingly, in the conventional EFI, even if a shared area is provided in the shared function library, it is not possible to share information on the shared area among modules. It is not possible to make a reference to the information during a phase switching.

### SUMMARY

Accordingly, a method for startup processing of an information processing apparatus including a processor, the method comprising: loading a first module among a plurality of modules embodying a part of the startup process of the information processing apparatus when executed by the processor, the first module comprising first shared information commonly used by two or more of the plurality of modules; storing access information for accessing the first shared information to a storage area provided in the information processing apparatus; loading a second module comprising interface information for accessing the access information; and accessing the access information by the second module using the interface information and obtaining the first shared information via the access information.

In addition, an information processing apparatus comprising: a processor; a first module setting unit that loads, during startup process, a first module among a plurality of modules embodying a part of the startup process of the information processing apparatus when executed by the processor, the first module comprising first shared information commonly used by two or more of the plurality of modules; an assess information setting units that stores, during the startup process, access information for accessing the first shared information to a storage area provided in the information processing apparatus; a second module setting unit that loads, during the startup process, a second module comprising interface information for accessing the access information; and a first obtainment unit that accesses, during the startup process, the access information by the second module using the interface information and obtaining the first shared information via the access information.

Furthermore, a computer-readable recording medium having a startup processing program stored thereon for making the compute execute startup processing, the startup processing program making the computer: load a first module among a plurality of modules embodying a part of the startup process of the information processing apparatus when executed by the computer, the first module comprising first shared information commonly used by two or more of the plurality of modules; store access information for accessing the first shared information to a storage area provided in the information processing apparatus; load a second module comprising interface information for accessing the access information; and access the access information by the second module using the interface information and obtaining the first shared information via the access information.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a diagram schematically illustrating an example of the hardware structure of an information processing apparatus as one example of an embodiment;

FIG. 2 is a diagram schematically illustrating program data P for an EFI stored in a BIOS flash in an information processing apparatus as one example of an embodiment;

FIG. 3 is a diagram schematically illustrating a module for each phase and load areas for various pieces of information for an EFI in an information processing apparatus as one example of an embodiment;

FIG. 4 is a diagram schematically illustrating a data lookup technique in an information processing apparatus as one example of an embodiment;

FIG. 5 is a flowchart illustrating processing of the EFI phase in an information processing apparatus as one example of an embodiment;

FIG. 6 is a flow chart illustrating processing of an SEC phase in an information processing apparatus as one example of an embodiment;

FIG. 7 is a flow chart illustrating processing of the PEI phase in an information processing apparatus as one example of an embodiment;

FIG. 8 is a flow chart illustrating processing of the DXE (BDS) phase in an information processing apparatus as one example of an embodiment;

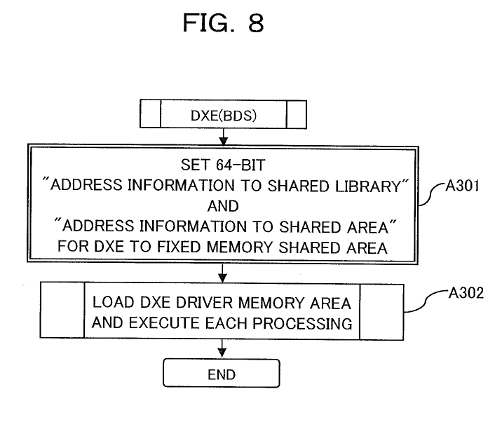

FIG. 9 is a flowchart illustrating a technique for reading a shared library SL in the PEI phase (CAR area) in an information processing apparatus as one example of an embodiment;

FIG. 10 is a diagram illustrating a reference path to a shared library SL in the PEI phase (CAR area) in an information processing apparatus as one example of an embodiment;

FIG. 11 is a flowchart illustrating a technique for reading shared area information stored in a shared area in the PEI phase (CAR area) in an information processing apparatus as one example of an embodiment;

FIG. 12 is a diagram illustrating a reference path to a shared area in the PEI phase (CAR area) in an information processing apparatus as one example of an embodiment;

FIG. 13 is a flowchart illustrating a technique for reading a shared library SL in the PEI phase (memory area) in an information processing apparatus as one example of an embodiment;

FIG. 14 is a diagram illustrating a reference path to an shared library SL in the PEI phase (memory area) in an information processing apparatus as one example of an embodiment;

FIG. 15 is a flowchart illustrating a technique for reading shared area information stored in a shared area in the PEI phase (memory area) in an information processing apparatus as one example of an embodiment;

FIG. 16 is a diagram illustrating a reference path to a shared area in the PEI phase (memory area) in an information processing apparatus as one example of an embodiment;

FIG. 17 is a flowchart illustrating a technique for reading a shared library SL in the DXE phase (memory area) in an information processing apparatus as one example of an embodiment;

FIG. 18 is a diagram illustrating a reference path to an shared library SL in the PEI phase (memory area) in an information processing apparatus as one example of an embodiment;

FIG. 19 is a flowchart illustrating a technique for reading shared area information stored in a shared area in the DXE phase (memory area) in an information processing apparatus as one example of an embodiment;

FIG. 20 is a diagram illustrating a reference path to a shared area in the DXE phase (memory area) in an information processing apparatus as one example of an embodiment;

FIG. 21 is a flowchart illustrating a technique for reading a shared library SL in the SMM phase (PEI and DXE) in an information processing apparatus as one example of an embodiment;

FIG. 22 is a diagram illustrating a reference path to an shared library SL in the SMM phase (PEI) and the SMM phase (DXE) in an information processing apparatus as one example of an embodiment;

FIG. 23 is a flowchart illustrating a technique for reading shared area information stored in a shared area in the SMM phase (PEI and DXE) in an information processing apparatus as one example of an embodiment;

FIG. 24 is a diagram illustrating a reference path to a shared area in the SMM phase (PEI) in an information processing apparatus as one example of an embodiment;

FIG. 25 is a diagram illustrating a reference path to a shared area in the SMM phase (DXE) in an information processing apparatus as one example of an embodiment;

FIG. 26 is a diagram illustrating each phase in an EFI;

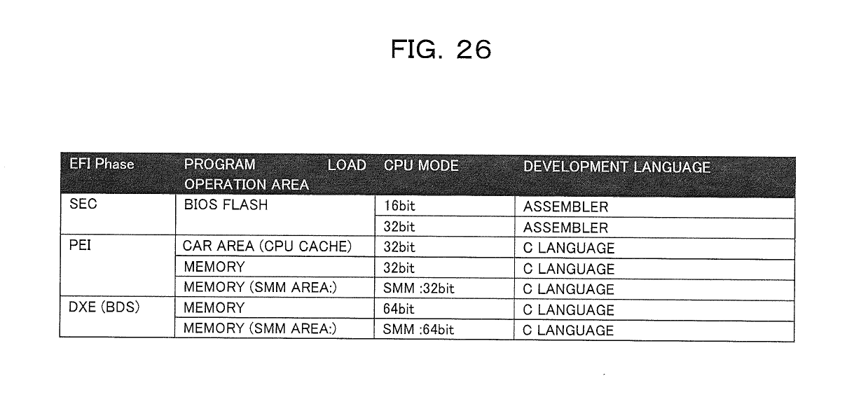

FIG. 27 is a diagram illustrating the module configuration in a conventional EFI; and

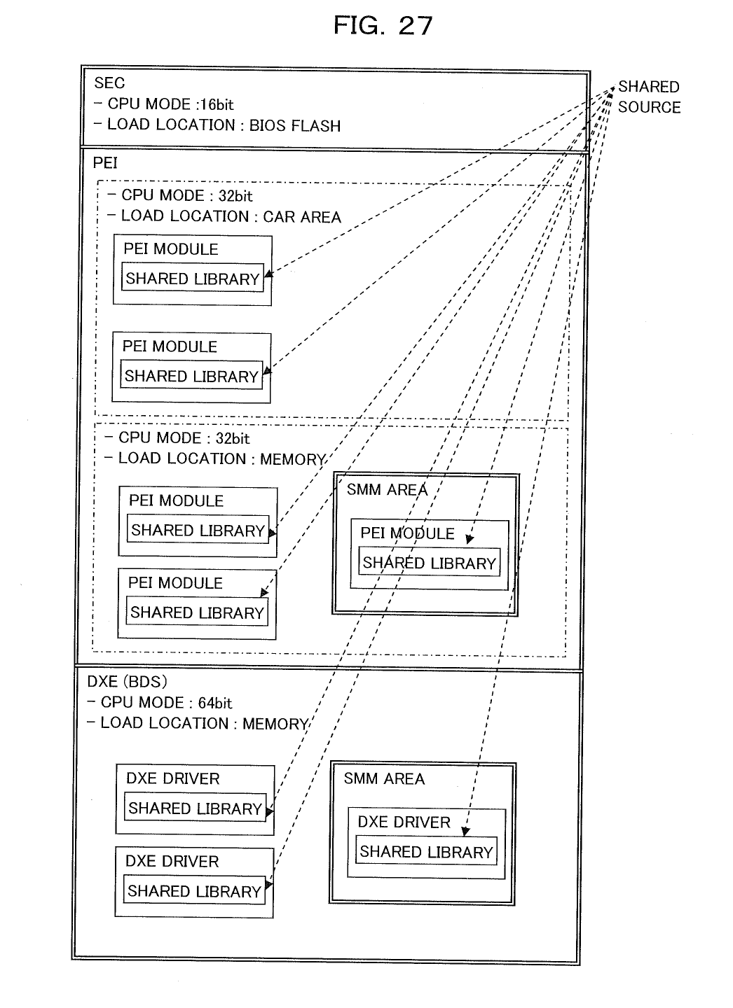

FIG. 28 is a diagram schematically illustrating a program load area for each phase in the EFI.

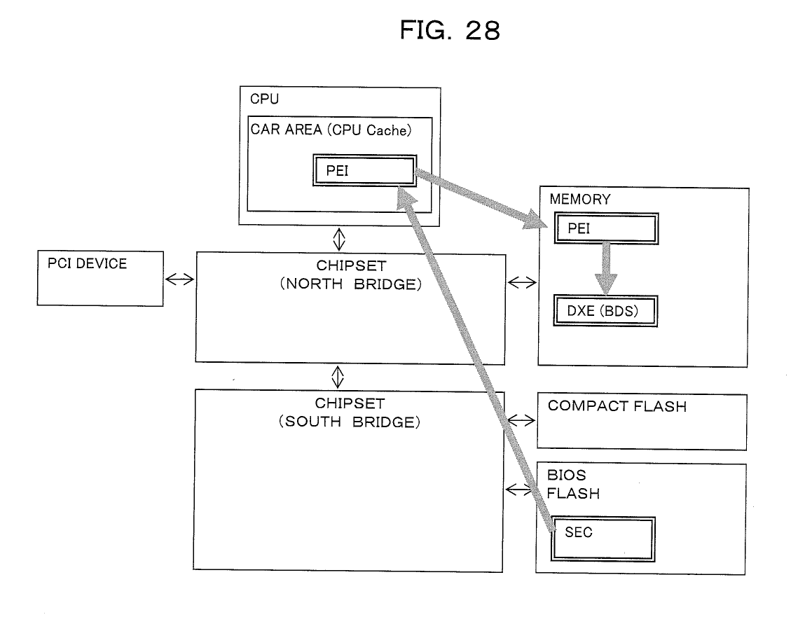

### DESCRIPTION OF EMBODIMENT(S)

Hereinafter, embodiments of a method for processing a startup, an information processing apparatus, and a startup program of the present disclosure will be described with reference to the drawings.

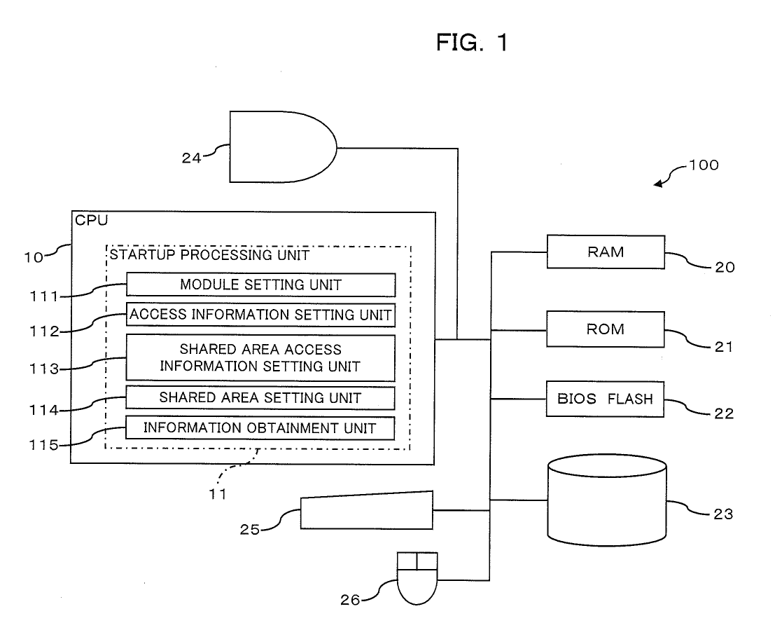

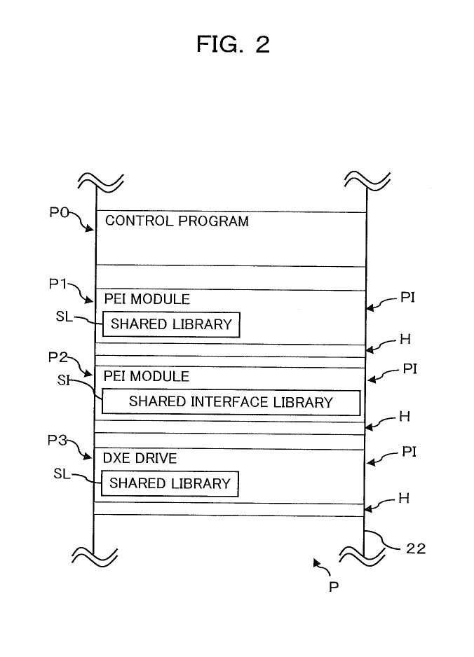

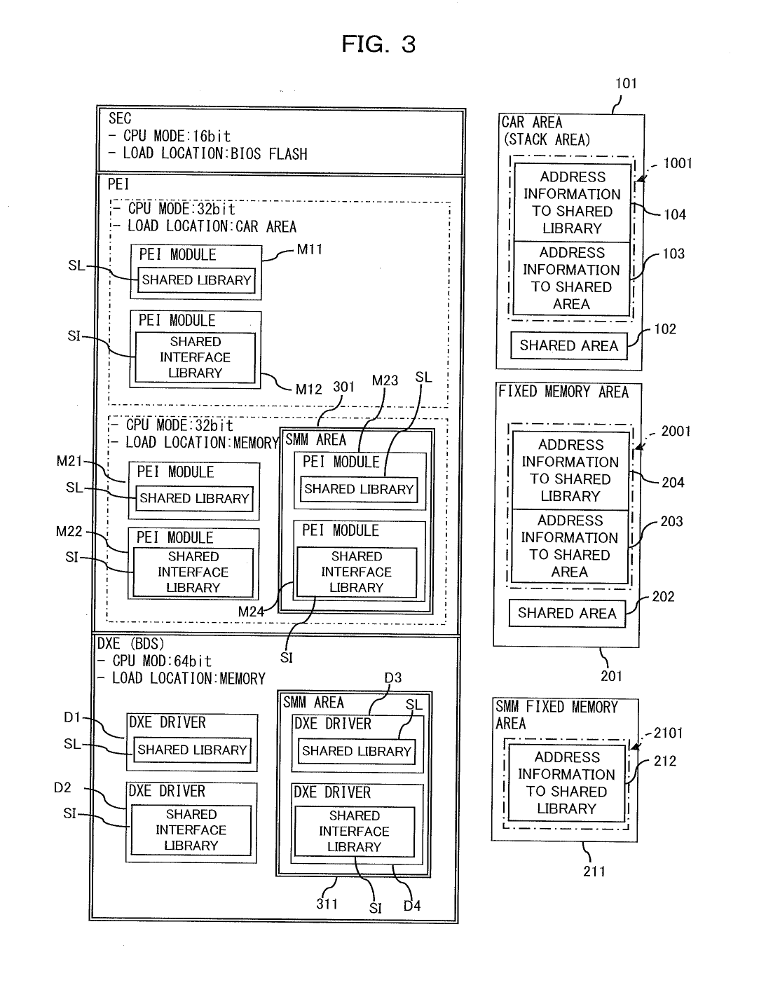

FIG. 1 is a diagram schematically illustrating an example of the hardware structure of an information processing apparatus as one example of an embodiment. FIG. 2 is a diagram schematically illustrating a program data P in an EFI stored in a BIOS flash 22 of an information processing apparatus 100 as one example of an embodiment. FIG. 3 is a diagram schematically illustrating a module for each phase and load areas for various pieces of information for an EFI in an information processing apparatus as one example of an embodiment.

The information processing apparatus 100 is a computer including a CPU 10, a RAM 20, a ROM 21, a BIOS flash 22, a storage 23, a display 24, a keyboard 25, and a mouse 26, as depicted in FIG. 1. In addition, the keyboard 25 and the mouse 26 are input devices, which are operated by an operator for providing various types of instructions, such as a restart instruction of the information processing apparatus 100 and input operations to input information. In addition, the information processing apparatus 100 also includes a power switch (not illustrated), which is operated by the operator for powering on the information processing apparatus 100.

The storage 23 is a storage apparatus, such as a hard disk drive (HDD) or solid state drive (SSD), and is adapted to the operating system, various programs, and stores various pieces of data.

The display 24 is a display device that displays, information, such as various pieces of data or a message for the operator.

The ROM 21 is a storage device that stores programs executed by the CPU 10 and various types of data.

The RAM 20 is a main storage device that temporarily stores various types of data and programs, and is used by the CPU 10 for temporarily storing and expanding the data and the programs when executing a program. In addition, during startup of the information processing apparatus 100, a predetermined storage area of the RAM 20 functions as a fixed memory area 201 (see FIG. 3) and an SMM fixed memory area 211 (see FIG. 3). The fixed memory area 201 includes a management area 2001 and a shared area 202, and the management area 2001 includes address information to the shared library 201, which will be described later, and the address information 203 to the shared area, which will also be described later. The detail of the shared are 202 will be also described below.

The BIOS flash 22 is a memory storing program data P of the EFI, and a flash memory (flash ROM), for example.

The program data P includes n (n is a natural number, n=3 in the example depicted in FIG. 2) module programs Pn (P1 to P3 in the example depicted in FIG. 2) and a control program P0 for controlling the startup processing, as depicted in FIG. 2. The module programs Pn are programs for embodying respective modules of the EFI, which will be described later, and are provided for each module. Each module program Pn includes a header section H and an executable image PI.

The control program P0 is a program being executed by the CPU 10, which will be described later, to achieve startup processing of the EFI thereby loading module programs Pn in a predetermined order. During startup of the information processing apparatus 100, startup processing is executed by the CPU 10 by sequentially reading executable images PI of the module programs Pn from the BIOS flash 22 in accordance with the control program P0, and expanding (loading) into a predetermined load area in the information processing apparatus 100.

In this way, an executable image PI of each module loaded to the predetermined area in the information processing apparatus 100 embodies the function of each module.

Although module programs P1 and P2 related to PEI modules and a module program P3 related to a DXE driver are depicted as examples of the module programs Pn in the example depicted in FIG. 2, this is not limiting. The module programs may include SEC modules or programs embodying other functions, and various modifications may be possible.

In addition, in the information processing apparatus of the present disclosure, the executable image P of each module program P1 stored in the BIOS flash 22 includes a shared library SL and a shared interface library SI.

The shared library SL is common information (first shared information) used by a plurality of modules, such as screen display on the display 24 or the input control of the keyboard 25 and the mouse 26, for example. The shared library SL is a library of functions commonly required by the plurality of modules, such that it is shared by the plurality of modules. The shared library SL can be not only used by a module including this shared library SL, but also by other modules including the shared interface library SI, which will be described later.

In addition, the shared library SL includes access functions for accessing the CAR area 101, which will be described later, and a predetermined area in the RAM 20. An address calculation is executed by the CPU 10, which will be described later, by executing the access functions for accessing the CAR area 101 and the predetermined area in the RAM 20, for example.

Thereby, the address information 103 to the shared area in the CAR area 101 can be accessed from the shared library SL in the PEI module M11, for example. Similarly, the address information 203 to the shared area in the fixed memory area 201 can be accessed from the shared library SL in the PEI module M21 or the PEI module M21. In addition, the address information 203 to the shared area in the fixed memory area 201 can be accessed from the shared library SL in the DXE driver D1 or the DXE driver D3.

The shared library SL functions as first shared information commonly used by two or more modules, of a plurality of modules embodying a part of startup process of the information processing apparatus 100.

It is preferable that the same shared library SL is not included in multiple groups having the same load area for each phase of the PEI, DXE, and SMM (DXE). In other words, preferably, one shared library SL is created for each group. Thereby, the volume required for storing the shared library SL can be reduced, and the size reduction of each module can be achieved. In other words, the sizes of program load operation areas for loading the BIOS flash 22 and various such modules can be reduced. Preferably, one shared library SL is created for each phase.

In the example depicted in FIG. 3, in the first group made of two PEI modules M11 and M12 expanded in the CAR area 101 during the initial stage of the PEI phase, the PEI module M11 includes a shared library SL. It should be noted that the PEI module M11 uses its own shared library SL. Hereinafter, in the PEI phase, a phase in which a load location of a module is in the CAR area 101 is referred to as the PEI phase (CAR area).

In addition, from the midway of the PEI phase, the RAM 20 is available, and thus a module is expanded into the RAM 20 (memory area). In the example depicted in FIG. 3, in the second group made of two PEI modules M21 and M22 expanded in the memory area, the PEI module M21 includes a shared library SL. It should be noted that the PEI module M21 uses its own shared library SL. Hereinafter, in the PEI phase, a phase in which a load location of a module is in the RAM 20 is referred to as the PEI phase (memory area).

Furthermore, in the example depicted in FIG. 3, in the third group made of two PEI modules M23 and M24 expanded in the SMM area 301 in the PEI phase, the PEI module M23 includes a shared library SL. It should be noted that the PEI module M23 uses its own shared library SL. Hereinafter, in the PEI phase, a phase in which a load location of a module is in the SMM is referred to as an SMM phase (PEI).

Similarly, in the example depicted in FIG. 3, in the fourth group made of two DXE drivers D1 and D2 expanded in the memory area in the DXE phase, the DXE driver D1 includes a shared library SL. It should be noted that the DXE drivers D1 and D3 use their own shared libraries SL. In addition, in the fifth group made of two DXE drivers D3 and D4 expanded in the SMM area 302 in the DXE phase, the DXE driver D3 includes a shared library SL. Hereinafter, in the DXE phase, a phase in which a load location of a module is in the SMM is referred to as an SMM phase (DXE).

A shared interface library SI is an interface for accessing shared libraries SL included in other modules or the shared areas 102 and 202, which will be described later, and includes pointers to predetermined addresses in the management areas 1001, 2001, and 2101, for example.

Each module can access the shared libraries SL or the shared areas 102 and 202 via the management areas 1001, 2001, and 2101, which will be described later, by using the shared interface library SI. In other words, the shared interface library SI functions as interface information for accessing shared area information stored in the shared libraries SL or the shared areas 102 and 202.

In addition, the BIOS flash 22 contains address information 104, 204, and 212 to shared libraries and address information 103, 203 to shared areas, which will be described later, and also contains shared information to be stored in the shared areas 102 and 202.

The CPU (processor) 10 is a processing apparatus that performs various types of computing and controls, and implements various functions by executing programs stored in the storage 23 or the like. In addition, the CPU 10 also includes a cache memory (processor cache) which is not illustrated. The cache memory is a storage area for temporarily storing information, such as, data or instructions, in which data, which the CPU 10 intends to access, attribute information of the data, such as the address, status, and setting of the data, are copied and stored. Note that the PEI module is expanded (loaded) to the cache memory in the PEI phase (CAR area), and the cache memory becomes an execution area of the PEI module.

The CPU 10 functions as a startup processing unit 11 for executing startup processing of the information processing unit 100, by executing a program P (control program P0) of the EFI stored in the BIOS flash 22, during startup of the information processing apparatus 100. Hereinafter, startup processing in the information processing apparatus 100 will be described. Note that such startup processing is executed when the information processing apparatus 100 is switched on or restarted, for example.

A program (startup processing program) for implementing the functions as the startup processing unit 11 is provided in the form of programs recorded on a computer readable recording medium, such as, for example, a flexible disk, a CD (e.g., CD-ROM, CD-R, CD-RW), a DVD (e.g., DVD-ROM, DVD-RAM, DVD-R, DVD+R, DVD-RW, DVD+RW), a magnetic disk, an optical disk, a magneto-optical disk, or the like. The computer then reads a program from that storage medium and uses that program after transferring it to the internal storage apparatus or external storage apparatus or the like. Alternatively, the program maybe recoded on a storage device (storage medium), for example, a magnetic disk, an optical disk, a magneto-optical disk, or the like, and the program may be provided to the computer through a communication path.

Upon embodying the functions as the setup processing unit 11, the program stored in an internal storage device (the RAM 20 and the ROM 21 in this embodiment) is executed by a microprocessor (the CPU 10 in this embodiment) of the computer. In this case, the computer may alternatively read a program stored in the storage medium for executing it.

Note that, in this embodiment, the term “computer” may be a concept including hardware and an operating system, and may refer to hardware that operates under the control of the operating system. Alternatively, when an application program alone can make the hardware to be operated without requiring an operating system, the hardware itself may represent a computer. The hardware includes at least a microprocessor, e.g., CPU, and a means for reading a computer program recorded on a storage medium and, in this embodiment, the information processing apparatus 100 includes a function as a computer.

The startup processing unit 11 executes startup processing of the information processing unit 100 in accordance with the EFI specification, and executes processing related to the initialization, beginning from the startup (power up) of the information processing apparatus 100 until the control is handed to the OS.

The startup processing unit 11 executes in line with the EFI specification, by sequentially executing four phases of the SEC, PEI, DXE, and DXE. In the EFI, the infrastructure available in each phase is provided by the key framework. Platform-dependent functions are embodied using modules which can communicate with each other. Hereinafter, a module in the PEI phase is referred to as a PEI module. In addition, module in the DXE phase includes a DXE driver and an EFI driver.

Note that PEI modules are made reference to by the reference symbols M11, M12, and M21-M24, while DXE drivers are made reference to by the reference symbols D1 to D4, in the example depicted in FIG. 3. Note that the reference symbols M11, M12, and M21-M24 are used hereinafter when reference is made to a specific PEI module while reference symbol M is used when reference is made to any of the multiple PEI modules. Furthermore, the reference symbol D1-D4 is used when reference is made to a specific DXE driver while reference symbol D is used when reference is made to any of the multiple DXE drivers.

The startup processing unit 11 includes a module setting unit 111, an access information setting unit 112, a shared area access information setting unit 113, a shared area setting unit 114, and an information obtainment unit 115, as depicted in FIG. 1, and startup processing is performed by the functions of such units.

The module setting unit 111 reads a module programs Pn corresponding to each module, from the BIOS flash 22, and functions as a loader that loads (sets, stores) it into a respective predetermined execution area (program load operation area, load area).

Hereinafter, loading an executable image PI of the module programs Pn corresponding to a module into a load area may be simply referred to as “loading a module”, for simplicity.

The module setting unit 111 loads an SEC module (not illustrated) in the BIOS flash 22, in the SEC phase. When the CPU 10 executes the SEC module in the BIOS flash 22, a cache for the CPU 10 is set and the function of the CAR is activated.

In addition, in the PEI phase, a PEI module M is loaded in the CAR area, the memory controller is initialized in the PEI, and an executable image P1 of each module is loaded in the memory after memory access to the RAM 20 is enabled.

The module setting unit 111 reads a PEI module M and data of the DXE driver D for executing each phase of the EFI from the BIOS flash 22, and loads them in respective predetermined execution areas in the cache memory 12 and the RAM 20 and the like.

Specifically, in the initial stage of the PEI phase, the module setting unit 111 expands the PEI module M read from the BIOS flash 22 to the CAR area 101 in the cache memory of the CPU 10. In addition, in the PEI phase, after the CPU 10 completes the initial setting of the RAM 20 by executing the PEI module M and thereby the RAM 20 is enabled and made available, the module setting unit 111 loads the PEI module M in the fixed memory area 201 or the SMM area 301 in the RAM 20.

In addition, in the DXE phase, the module setting unit 111 loads the DXE driver D read from the BIOS flash 22 in the RAM 20 or the SMM area 311 in the RAM 20.

The modules loaded by the module setting unit 111 include ones including a shared library SL or a shared interface library SI. In other words, during startup processing, the module setting unit 111 functions as a first module setting unit that loads modules including the shared library SL commonly used by two or more modules. Furthermore, during startup processing, the module setting unit 111 also functions as a second module setting unit that loads modules including the shared interface library SI.

The shared area setting unit 114 sets shared areas 102 and 202 for storing shared area information (second shared information) in the CAR area 101 in the cache memory of the CPU 10 or the fixed memory area 201 in the RAM 20.

Here, the shared area information is information commonly used by a plurality of phases of the EFI, such as the memory size or the type of the CPU 10, for example. Such shared area information is commonly used (shared) by modules of different phases, such as the PEI module M of the PEI phase and the DXE driver D of the DXE phase, for example.

In the initial stage of the PEI phase, the shared area setting unit 114 reserves the shared area 102 in a predetermined location in the CAR area 101, reads shared area information from the BIOS flash 22, and store the shared area information that is read to the shared area 102. Preferably, shared area information is stored in the shared area 102 with no duplication of the shared area information.

In addition, after the RAM 20 is enabled in the PEI phase, the shared area setting unit 114 reserves the shared area 202 in a predetermined location in the fixed memory area 201 in the RAM 20. The shared area setting unit 114 then reads the shared area information stored in the shared area 102 in the CAR area 101, and stores the shared area information that is read to the shared area 202. In other words, the shared area setting unit 114 copies the shared area information in the shared area 102 in the CAR area 101 to the shared area 202 in the fixed memory area 201.

Thereby, the shared area information used in the PEI phase (CAR area) can also be used (shared) in the PEI phase (memory area), the DXE phase, the SMM phase (PEI), or the SMM phase (DXE).

The access information setting unit 112 stores (sets) address information 104, 204, and 212 to the shared library in the CAR area 101 in the cache memory of the CPU 10, and the fixed memory area 201 and the SMM fixed memory area 211 in the RAM 20.

Specifically, in the initial stage of the PEI phase, the access information setting unit 112 reads address information to the PEI 32-bit shared library from the BIOS flash 22, and stores the address information to the shared library which is read to a predetermined area in the CAR area 101 in the cache memory of the CPU 10.

Here, the address information to the shared library 104 is address information for accessing a shared library SL included in a module, and includes an pointer to the shared library SL, for example. In addition, as pointer to the shared library SL, in addition to a pointer indicating an address (shared information pointer), a function pointer is also used.

In addition, after the RAM 20 is enabled, the access information setting unit 112 reads address information 204 to the PEI 32-bit shared library from the BIOS flash 22, and stores the address information 204 to the PEI 32-bit shared library which is read to the fixed memory area 201 in the RAM 20.

Furthermore, for an SMM (System Management Mode) area in the RAM 20, the access information setting unit 112 sets address information 212 to the shared library in an SMM fixed memory area 211, which is a certain area.

In the PEI phase, the access information setting unit 112 reads address information 212 to the DXE 64-bit shared library from the BIOS flash 22, and stores the address information 212 to the DXE 64-bit shared library which is read to the SMM fixed memory area 211.

Note that the shared area information can be shared for the PEI 32-bit and DXE 64-bit shared libraries.

The shared area access information setting unit 113 stores the address information 103 and 203 to the shared area in the CAR area 101 in the cache memory of the CPU 10 and the fixed memory area 201 in the RAM 20.

Specifically, in the initial stage of the PEI phase, the shared area access information setting unit 113 stores the address information 103 to the shared area in a predetermined area in the CAR area 101 in the cache memory of the CPU 10.

Here, the address information 103 to the shared area is information for accessing the shared area 102 (shared area access information), and is a pointer indicating a storage location of the shared area information in the shared area 102 (shared information pointer) for example. Thereby, a module accessing the shared library SL 103 can access the shared area information stored in the shared area 102.

Similarly, after the RAM 20 is made available, the shared area access information setting unit 113 stores address information 203 to the shared area in a predetermined area in the RAM 20.

Here, the address information 203 to the shared area is shared area access information for information for accessing the shared area 202, and is a pointer indicating a storage location of the shared area information in the shared area 202 (shared information pointer) for example. Thereby, a module accessing the shared library SL 203 can access the shared area information stored in the shared area 202.

Note that the area in the CAR area 101, in which the address information to the shared library 104 and the address information 103 to the shared area are stored, is sometimes referred to as a management area 1001. Similarly, the area in the RAM 20 (the fixed memory area 201), in which the address information to the shared library and the address information to the shared area are stored, is sometimes referred to as a management area 2001. In addition, the area in the SMM in the RAM 20 (fixed memory area 211), in which the address information to the shared library is stored, is sometimes referred to as a management area 2101.

During the startup processing for the information processing apparatus 100, the information obtainment unit 115 refers to and obtains the shared library SL or the shared area information, when executing modules, such as the PEI module M or the DXE driver D.

The information obtainment unit 115 obtains the shared library SL using the shared interface library SI and the address information 104, 204, and 212 to the shared library, as described in detail below. In other words, the information obtainment unit 115 functions as a first information obtainment unit. In addition, the information obtainment unit 115 obtains the shared area information of the shared areas 102 and 202, using the shared interface library SI, the address information 104, 204, and 212 to the shared library, the shared library SL, and the address information 103 and 203 to the shared area, as described in detail below. In other words, the information obtainment unit 115 functions as a second information obtainment unit.

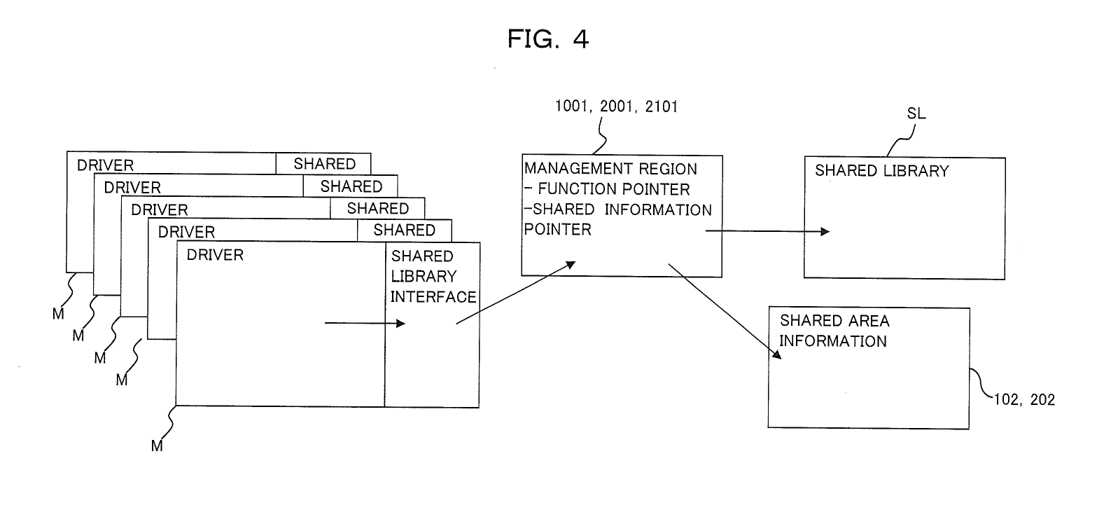

FIG. 4 is a diagram schematically illustrating a data lookup technique in the information processing apparatus 100 as one example of an embodiment.

The startup processing unit 11 accesses the management areas 1001, 2001, and 2101 via each shared interface library SI, when executing a module including the shared interface library SI. The startup processing unit 11 then accesses the address information 104, 204, and 212 to the shared library and the address information 103 and 203 to the shared area stored in the management areas 1001, 2001, and 2101. The startup processing unit 11 accesses the shared library SL or shared area information using these pieces of information, and executes the startup processing for the information processing apparatus 100 using these pieces of information.

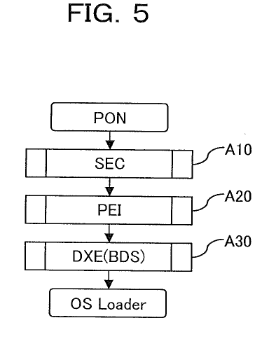

Processing of the EFI phase during startup in the information processing apparatus 100 configured as described above as one example of an embodiment will be described with reference to the flowchart depicted in FIG. 5 (A10-A30).

After the information processing apparatus 100 as one example of an embodiment is powered on (PON: Power ON), the SEC phase is executed (step A10). Thereafter, the PEI phase is executed (step A20), and then the DXE (BDS) phase is executed (step A30). Once the initialization of the system is completed in the processing during each phase of the EFI, the startup processing of the OS by the OS loader is initiated.

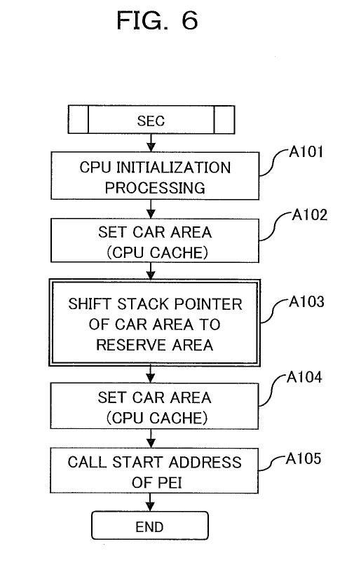

Next, processing of the SEC phase in the information processing apparatus 100 as one example of an embodiment will be described with reference to the flowchart depicted in FIG. 6 (A101-A105).

In the SEC phase, after initializing the CPU 10 (step A101), the CAR area 101 (CPU cache) is set (step A102).

Then, by shifting the stack pointer of the CAR area 101 by a predetermined bit, the address information to the shared library 104, the address information 103 to the shared area, and the area for the shared area 102 is reserved (step A103). Note that the bit count for shifting the stack pointer corresponds to the size of the address information to the shared library 104, the address information 103 to the shared area, and the shared area 102.

Thereafter, the CAR area 101 is set (step A104), the start address of PEI in the BIOS flash 22 is read (step A105), and the SEC phase is terminated.

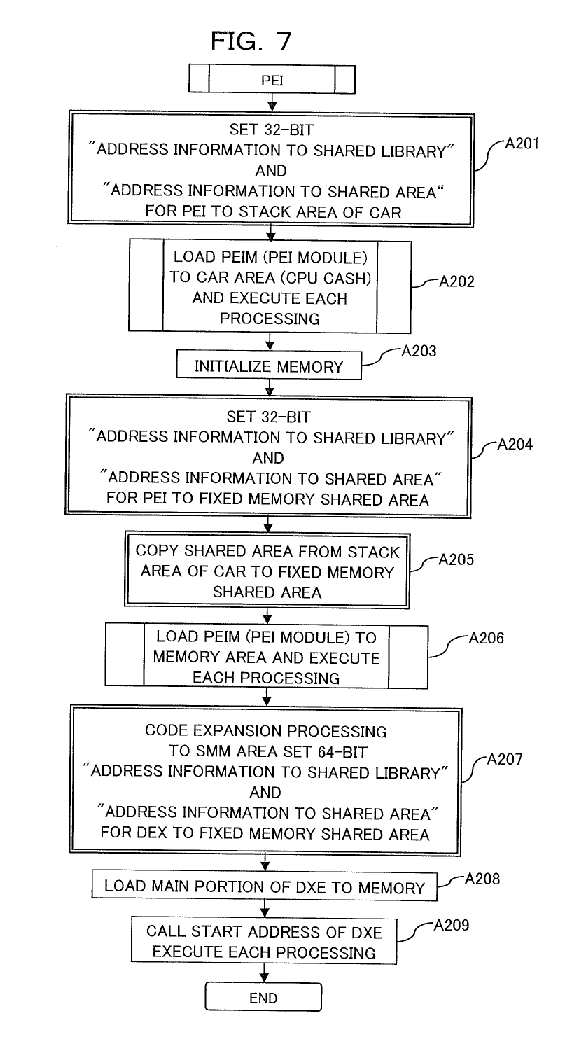

Next, processing of the PEI phase in the information processing apparatus 100 as one example of an embodiment will be described with reference to the flowchart depicted in FIG. 7 (Steps A201-A209).

In the PEI phase, firstly, the access information setting unit 112 and the shared area access information setting unit 113 set the 32-bit address information to the shared library 104 for the PEI and address information 103 to the shared area in a CAR stack area (step A201).

Next, the module setting unit 111 reads the PEI modules from the BIOS flash 22, loads it to the CAR area 101, and executes the respective PEI modules (step A202). The PEI modules execute initialization of the RAM 20 (step A203) to make the RAM 20 available.

The access information setting unit 112 and the shared area access information setting unit 113 set 32-bit address information to the shared library 204 for the PEI and 32-bit address information to the shared area 203 for the PEI in the fixed memory area 201 (step A204).

In addition, the shared area setting unit 114 copies shared area information stored in the shared area 102 in the CAR area 101 to the shared area 202 in the fixed memory area 201 (step A205). This invalidates the cache.

The module setting unit 111 loads the PEI modules M to the RAM 20 (memory area) to make processing of the respective PEI modules M to be executed (step A206).

Next, the access information setting unit 112 and the shared area access information setting unit 113 set 32-bit address information to the shared library 204 for the PEI and 32-bit address information to the shared area 203 for the PEI in the fixed memory area 201 (step A207).

Thereafter, the main portion of the DXE is leaded to the RAM 20 (step A208), the start address of the DXE core in the RAM 20 is read (step A209), and the processing is terminated.

Next, processing of the DXE (BDS) phase in the information processing apparatus 100 as one example of an embodiment will be described with reference to the flowchart depicted in FIG. 5 (A301-A302).

In the DXE (BDS) phase, firstly, the access information setting unit 112 and the shared area access information setting unit 113 set the 64-bit address information to the shared library 104 for the PEI and address information 103 to the shared area in a fixed memory area 201 (step A301).

Next, the DXE (BDS) phase is completed by the module setting unit 111 by reading the DXE driver D from the BIOS flash 22 and loading it to the RAM 20, and executing the respective DXE drivers (step A302).

Although the 32-bit address information 204 to the shared library for the PEI and the 32-bit address information 203 to the shared area for the PEI are set in the fixed memory area 201 in the midway of the PEI phase (see step A207) in the example depicted in FIG. 7, this is not limiting.

For example, they may be set after the DXE drivers are loaded to the RAM 20 in the step A302 in DXE (BDS) phase, and are executed, and various modifications may be possible.

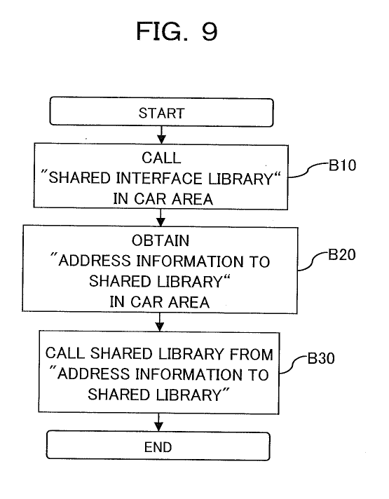

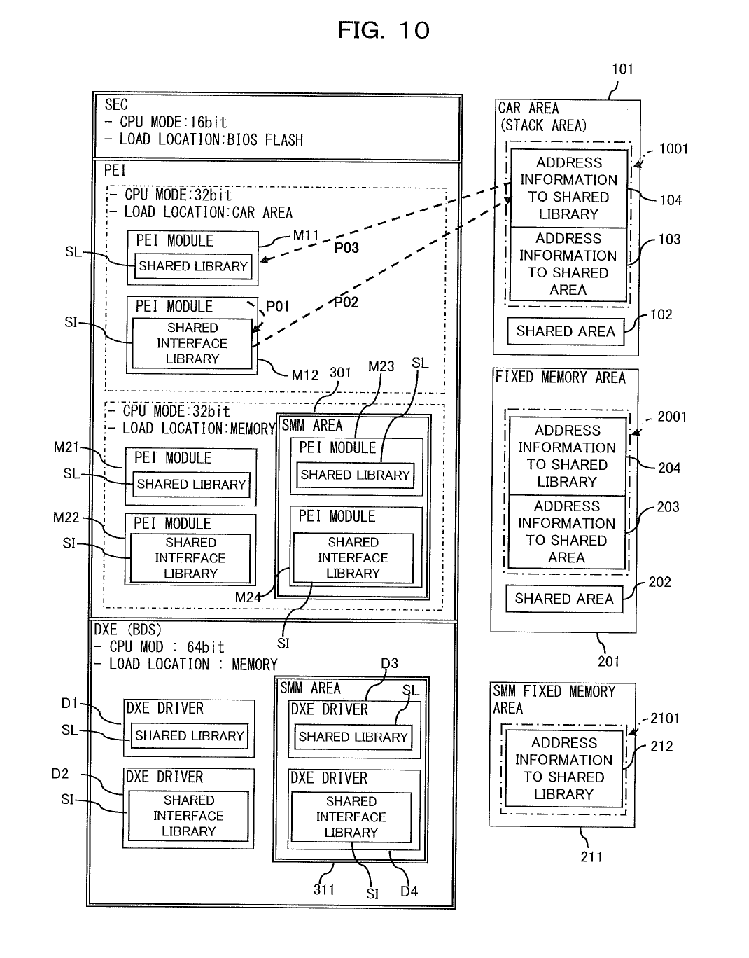

Next, a technique for reading a shared library SL in the PEI phase (CAR area) in the information processing apparatus 100 as one example of an embodiment will be described with reference to a flowchart depicted in FIG. 9 (will be described with reference to steps B10 to B30), as well as referring to FIG. 10. Note that FIG. 10 is a diagram illustrating a reference path to a shared library SL in the PEI phase (CAR area) in the information processing apparatus 100.

An example in which the PEI module M12 (second module) uses the function of the shared library SL in the PEI module M11 (first module) in the PEI phase (CAR area), will be described.

In the CAR area, the PEI module M12 calls the shared interface library SI (step B10: see reference symbol P01 in FIG. 10), and obtains the address information to the shared library 104 in the CAR area 101 (step B20: see reference symbol P02 in FIG. 10). The PEI module M12 calls the function in the shared library SL in the PEI module M11 using this address information to the shared library 104 (step B30: see reference symbol P03 in FIG. 10).

As described above, in the PEI phase (CAR area), a PEI module M12 can read the shared library SL in the PEI module M11 via the address information to the shared library 104 in the CAR area 101, using the shared interface library SI. The PEI module M11 also can use its own shared library SL.

Accordingly, the shared library SL in the PEI module M11 can be shared by the PEI module M11 and the PEI module M12.

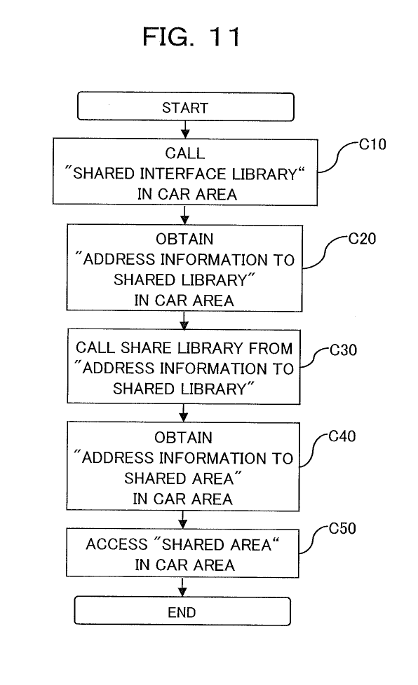

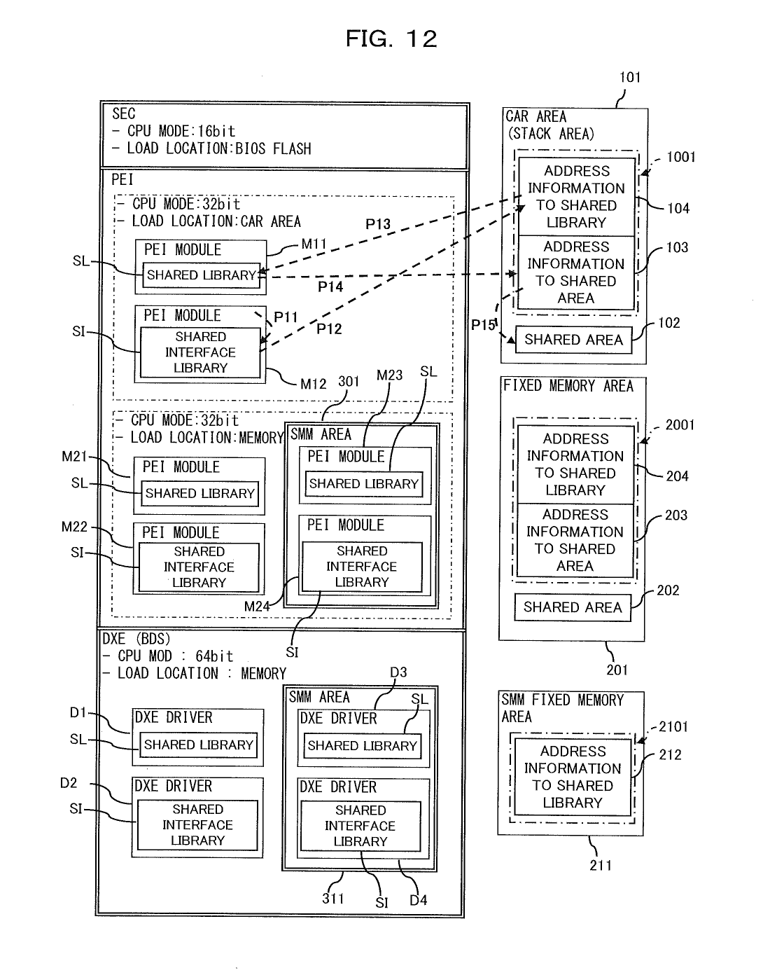

Next, a technique for reading shared area information stored in a shared area in the PEI phase (CAR area) in the information processing apparatus 100 as one example of an embodiment will be described with reference to a flowchart depicted in FIG. 11 (will be described with reference to steps C10 to C50), as well as referring to FIG. 12. Note that FIG. 12 is a diagram illustrating a reference path to the shared area 102 in the PEI phase (CAR area) in the information processing apparatus 100.

In the CAR area, the PEI module M12 (second module) calls the shared interface library SI (step C10: see reference symbol P11 in FIG. 12), and obtains the address information to the shared library 104 in the CAR area 101 (step C20: see reference symbol P12 in FIG. 12). The PEI module M12 calls the function in the shared library SL in the PEI module M11 (first module) using this address information to the shared library 104 (step C30: see reference symbol P13 in FIG. 12).

The PEI module M12 obtains information to access the address information 103 to the shared area in the CAR area 101 (for example, a pointer), from this shared library SL, and obtains the address information 103 to the shared area in the CAR area 101, based on this information (step C40: see reference symbol P14 in FIG. 12). The PEI module M12 accesses the shared area 102 in the CAR area 101, using this address information 103 to the shared area (step C50: see reference symbol P15 in FIG. 12), and obtains the shared area information stored in the shared area 102.

As described above, in the PEI phase (CAR area), the PEI module M12 reads the shared library SL in the PEI module M11 via the address information to the shared library 104 in the CAR area 101, using the shared interface library SI. Then, the PEI module M12 can obtain the address information 103 to the shared area in the CAR area 101, using this shared library SL, and obtain the shared area information, using this address information 103 to the shared area.

The PEI module M11 also can obtain the address information 103 to the shared area in the CAR area 101, using its own shared library SL, and obtain the shared area information, using this address information 103 to the shared area.

Accordingly, the shared area information in the shared area 102 in the CAR area 101 can be shared by the PEI module M11 and the PEI module M12.

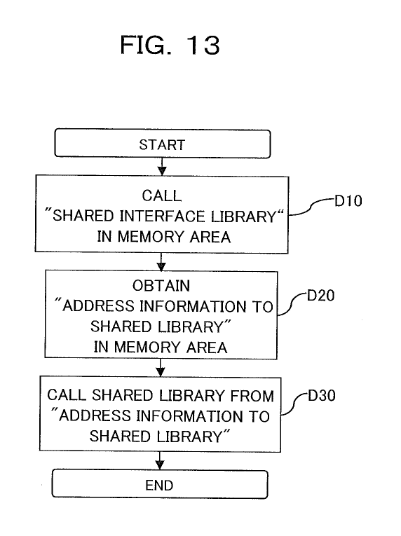

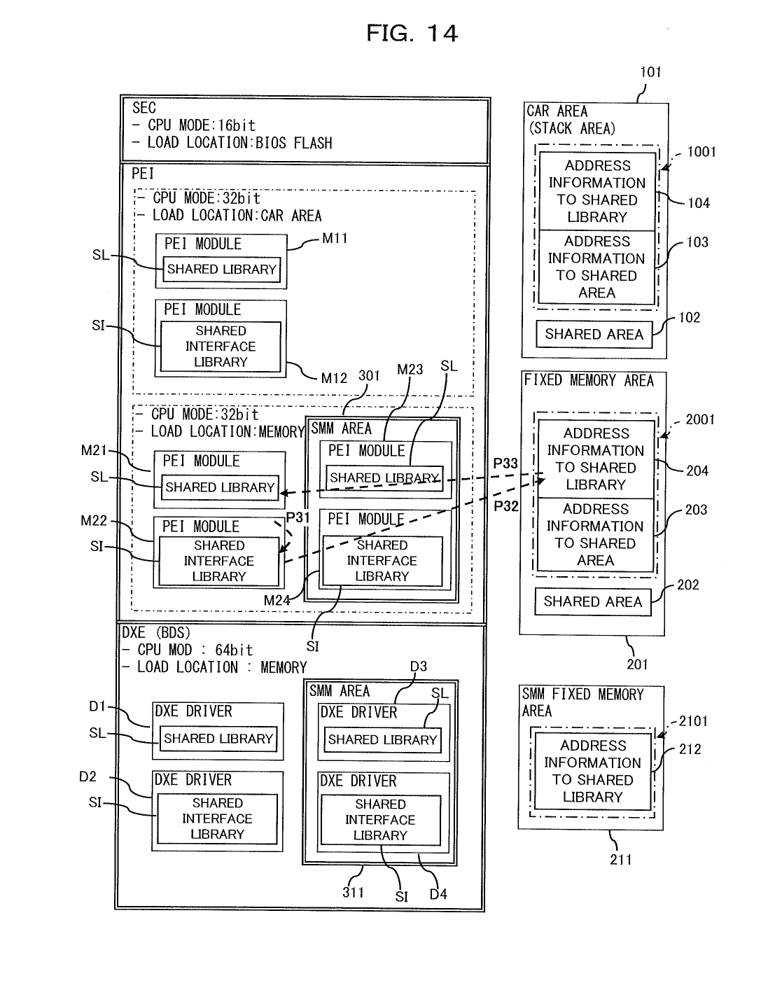

Next, a technique for reading a shared library SL in the PEI phase (memory area) in the information processing apparatus 100 as one example of an embodiment will be described with reference to a flowchart depicted in FIG. 13 (will be described with reference to steps D10 to F30), as well as referring to FIG. 14. Note that FIG. 14 is a diagram illustrating a reference path to a shared library SL in the PEI phase (memory area) in the information processing apparatus 100.

An example in which the PEI module M22 (second module) uses the function of the shared library SL in the PEI module M21 (first module) in the PEI phase (memory area), will be described.

In the memory area, the PEI module M22 calls the shared interface library SI (step D10: see reference symbol P31 in FIG. 14), and obtains the address information to the shared library 204 in the fixed memory area 201 (step D20: see reference symbol P32 in FIG. 14). The PEI module M22 calls the function in the shared library SL in the PEI module M21 using this address information 204 to the shared library (step D30: see reference symbol P33 in FIG. 14).

As described above, in the PEI phase (memory area), the PEI module M22 can read the shared library SL in the PEI module M21 via the address information 204 to the shared library in the fixed memory area 201, using the shared interface library SI. The PEI module M21 also can use its own shared library SL.

Accordingly, the shared library SL in the PEI module M21 can be shared by the PEI module M21 and the PEI module M22.

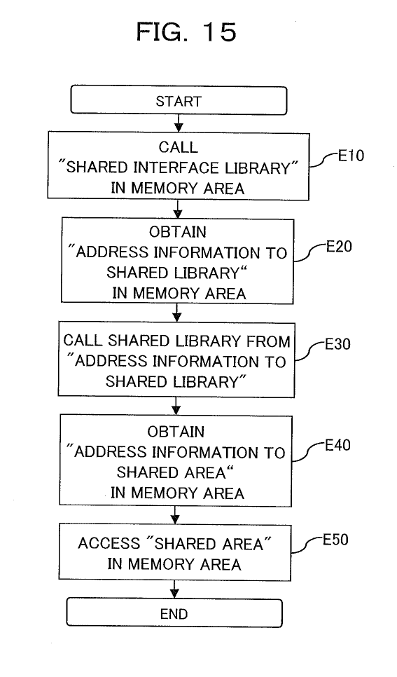

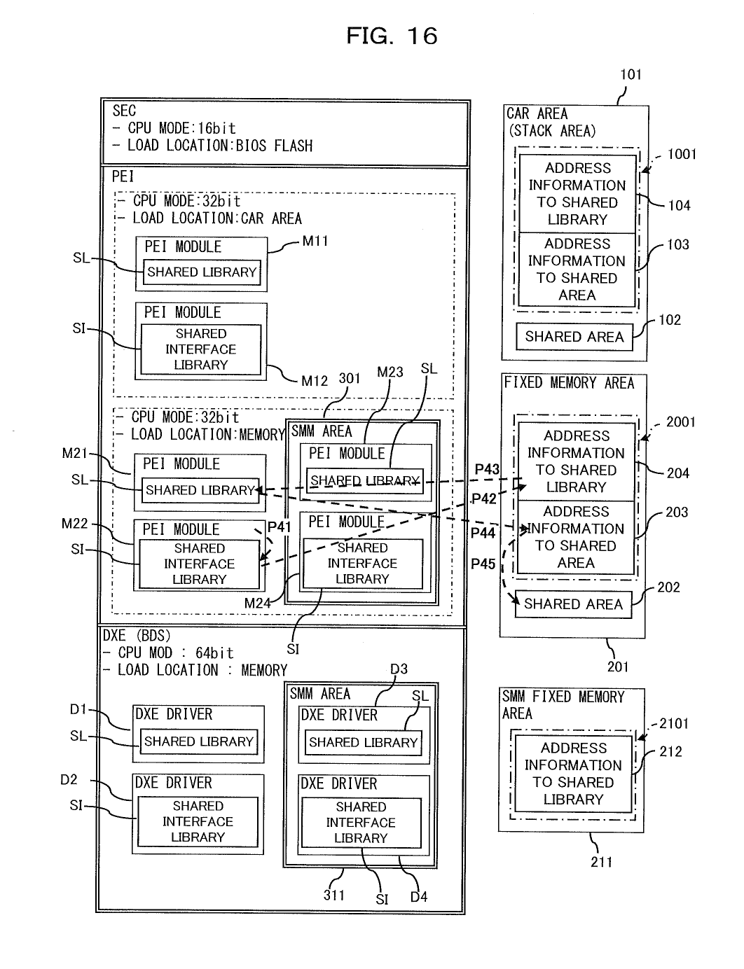

Next, a technique for reading shared area information stored in a shared area 202 in the PEI phase (memory area) in the information processing apparatus 100 as one example of an embodiment will be described with reference to a flowchart depicted in FIG. 15 (will be described with reference to steps E10 to E50), as well as referring to FIG. 16. Note that FIG. 16 is a diagram illustrating a reference path to the shared area 202 in the PEI phase (memory area) in the information processing apparatus 100.

In the memory area, the PEI module M22 (second module) calls the shared interface library SI (step E10: see reference symbol P41 in FIG. 16), and obtains the address information 204 to the shared library in the fixed memory area 201 (step E20: see reference symbol P42 in FIG. 16). The PEI module M22 calls the shared library SL in the PEI module M21 (first module) using this address information 204 to the shared library (step E30: see reference symbol P43 in FIG. 16).

The PEI module M22 obtains information to access the address information 203 to the shared area in the shared memory area 201 (for example, a pointer), from this shared library SL, and obtains the address information 203 to the shared area in the fixed memory area 201, based on this information (step E40: see reference symbol P44 in FIG. 16). The PEI module M22 accesses the shared area 202 in the fixed memory area 201, using this address information to the shared area 203 (step E50: see reference symbol P45 in FIG. 16), and obtains the shared area information stored in the shared area 202.

As described above, in the PEI phase (memory area), the PEI module M22 reads the shared library SL in the PEI module M21 via the address information 204 to the shared library in the fixed memory area 201, using the shared interface library SI. Then, the PEI module M12 can obtain the address information 203 to the shared area in the fixed memory area 201, using this shared library SL, and obtain the shared area information, using this address information 203 to the shared area.

The PEI module M21 also can obtain the address information 203 to the shared area in the fixed memory area 201, using its own the shared library SL, and obtain the shared area information, using this address information 203 to the shared area.

Accordingly, the shared area information in the shared area 202 in the fixed memory area 201 can be shared by the PEI module M21 and the PEI module M22.

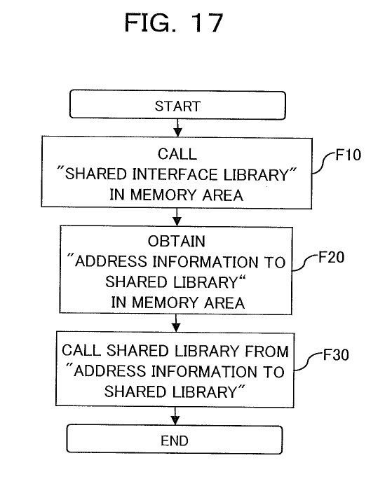

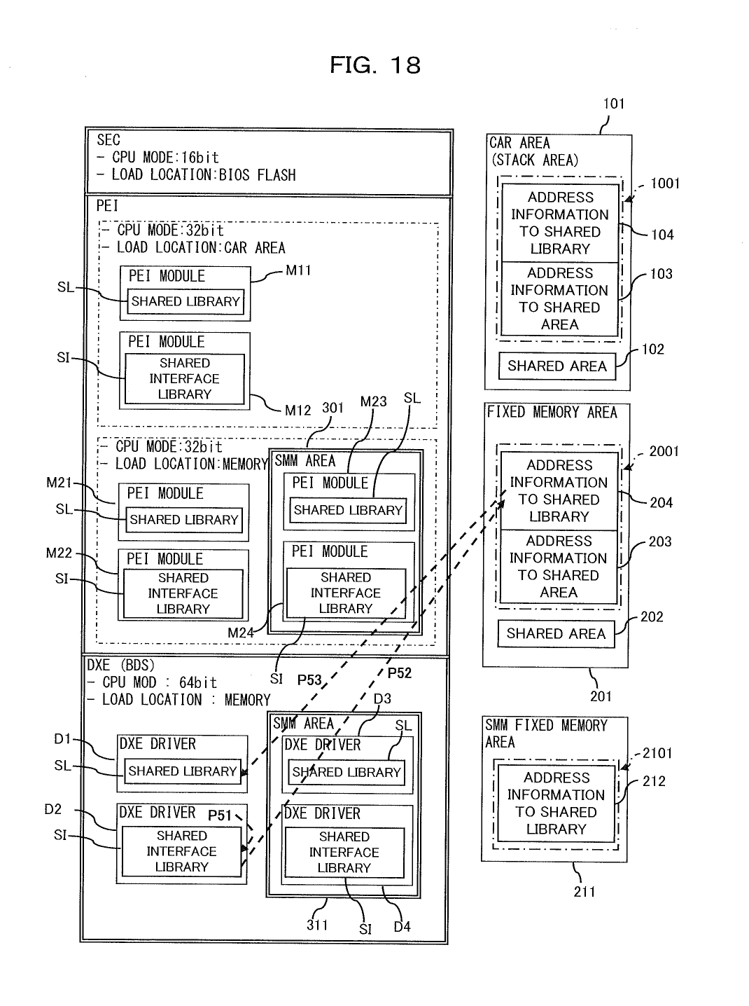

Next, a technique for reading a shared library SL in the DXE phase in the information processing apparatus 100 as one example of an embodiment will be described with reference to a flowchart depicted in FIG. 17 (will be described with reference to steps F10 to F30), as well as referring to FIG. 18. Note that FIG. 18 is a diagram illustrating a reference path to a shared library SL in the DXE phase (memory area) in the information processing apparatus 100.

An example in which the DXE driver D2 (second module) uses the function of the shared library SL in the DXE driver D1 (first module) in the DXE phase (memory area), will be described.

In the memory area, the DXE driver D2 calls the shared interface library SI (step F10: see reference symbol P51 in FIG. 18), and obtains the address information 204 to the shared library in the fixed memory area 201 (step F20: see reference symbol P52 in FIG. 18). The DXE driver D2 calls the function in the shared library SL in the DXE driver D1 using this address information 204 to the shared library (step F30: see reference symbol P53 in FIG. 18).

As described above, in the DXE phase (memory area), the DXE driver D2 can read the shared library SL in the DXE driver D1 via the address information 204 to the shared library in the fixed memory area 201, using the shared interface library SI. The DXE driver D1 also can use its own shared library SL.

Accordingly, the shared library SL in the DXE driver D1 can be shared by the DXE driver D1 and the DXE driver D2.

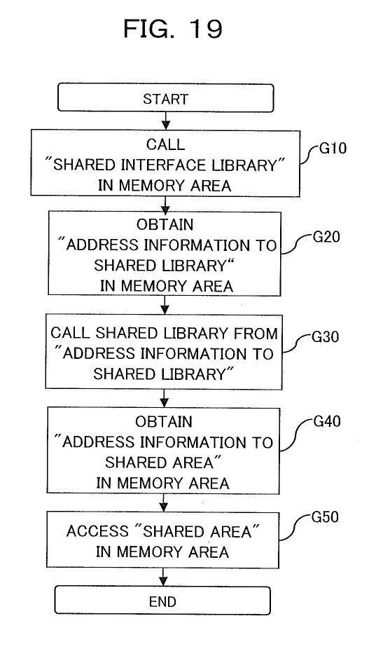

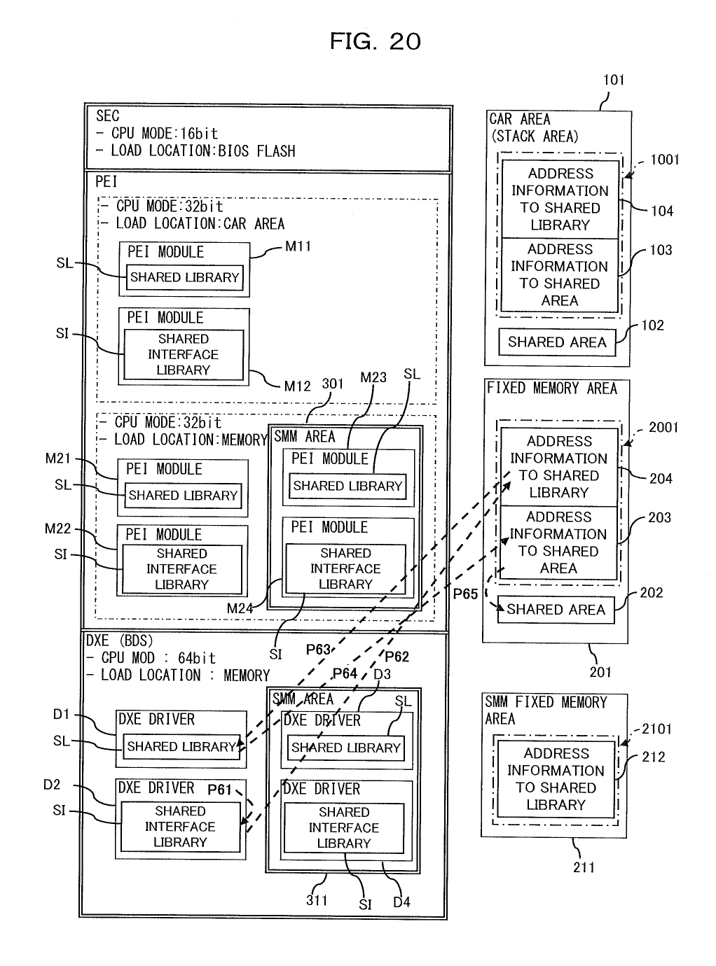

Next, a technique for reading shared area information stored in a shared area 202 in the DXE phase (memory area) in the information processing apparatus 100 as one example of an embodiment will be described with reference to a flowchart depicted in FIG. 19 (will be described with reference to steps G10 to G50), as well as referring to FIG. 20. Note that FIG. 20 is a diagram illustrating a reference path to the shared area 202 in the DXE phase (memory area) in the information processing apparatus 100.

In the memory area, the DXE driver D2 (second module) calls the shared interface library SI (step G10: see reference symbol P61 in FIG. 20), and obtains the address information 204 to the shared library in the fixed memory area 201 (step G20: see reference symbol P62 in FIG. 20). The DXE driver D2 calls the shared library SL in the DXE driver D1 (first module) using this address information 204 to the shared library (step G30: see reference symbol P63 in FIG. 2).

The DXE driver D2 obtains information to access the address information 203 to the shared area in the shared memory area 201 (for example, a pointer), from this shared library SL, and obtains the address information 203 to the shared area in the fixed memory area 201, based on this information (step G40: see reference symbol P64 in FIG. 20). The DXE driver D2 accesses the shared area 202 in the fixed memory area 201, using this address information 203 to the shared area (step G50: see reference symbol P65 in FIG. 20), and obtains the shared area information stored in the shared area 202.

As described above, in the DXE phase (memory area), the DXE driver D2 reads the shared library SL in the DXE driver D1 via the address information 204 to the shared library in the fixed memory area 201, using the shared interface library SI. Then, the PEI module M12 can obtain the address information 203 to the shared area in the fixed memory area 201, using this shared library SL, and obtain the shared area information, using this address information to the shared area 203.

The DXE driver D1 also can obtain the address information 203 to the shared area in the fixed memory area 201, using its own the shared library SL, and obtain the shared area information, using this address information 203 to the shared area.

Accordingly, the shared area information in the shared area 202 in the fixed memory area 201 can be shared by the DXE driver D1 and the DXE driver D2.

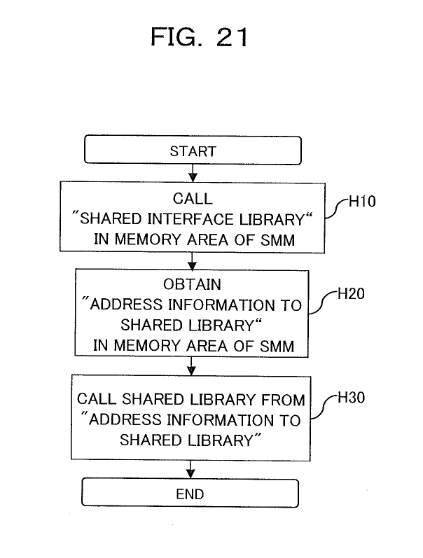

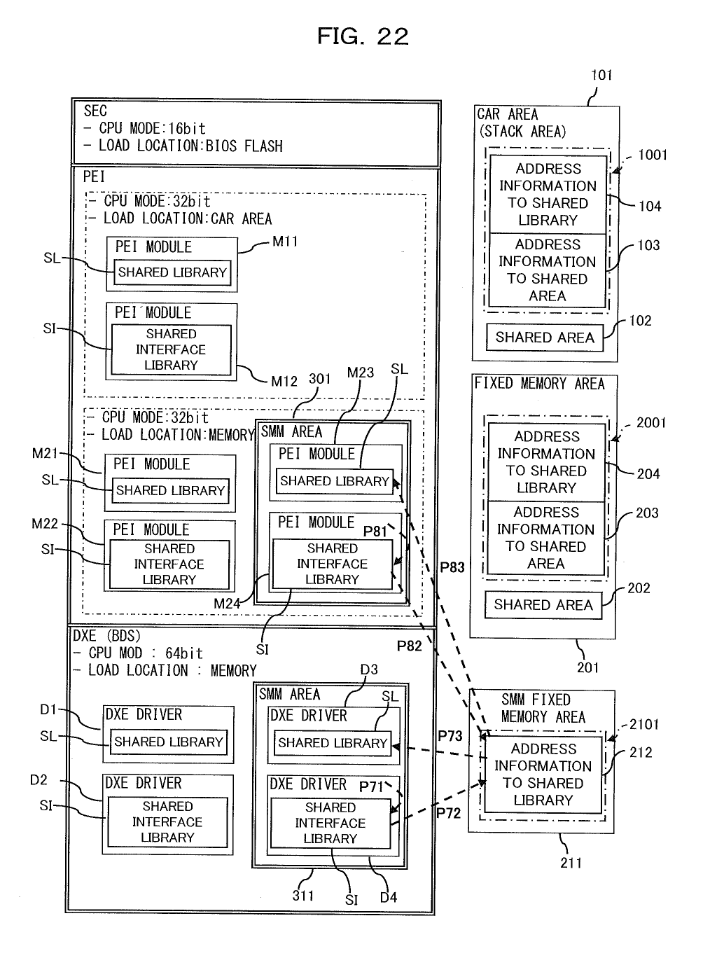

Next, a technique for reading a shared library SL in the SMM phase (PEI and DXE) in the information processing apparatus 100 as one example of an embodiment will be described with reference to a flowchart depicted in FIG. 21 (will be described with reference to steps H10 to H30), as well as referring to FIG. 22. Note that FIG. 22 is a diagram illustrating a reference path to a shared library SL in the SMM phase (PEI) and the SMM phase (DXE) in the information processing apparatus 100.

Here, an example in which the PEI module M24 (second module) uses the function of the shared library SL in the PEI module M23 (first module) and another example in which the DXE driver D4 (second module) uses the function of the shared library SL in the DXE driver D3 (first module) in the DXE phase (memory area), will be described together.

In the SMM area, the PEI module M24 calls the shared interface library SI (step H10: see reference symbol P81 in FIG. 22) , and obtains the address information 212 to the shared library 212 in the fixed memory area 211 of the SMM (step H20: see reference symbol P82 in FIG. 22). The PEI module M24 calls the function in the shared library SL in the PEI module M23 using this address information 212 to the shared library (step H30: see reference symbol P83 in FIG. 22).

Similarly, in the SMM area, the DXE driver D4 calls the shared interface library SI (step H10: see reference symbol P71 in FIG. 22), and obtains the address information 212 to the shared library in the fixed memory area 211 of the SMM (step H20: see reference symbol P72 in FIG. 22). The DXE driver D4 calls the function in the shared library SL in the DXE driver D3 using this address information 212 to the shared library (step H30: see reference symbol P73 in FIG. 22).

As described above, in either the SMM phase (PEI) or the SMM phase (DXE), the PEI module M24 or the DXE driver D4 can read the shared library SL in PEI module M23 or the DXE driver D3 via the address information 211 to the shared library in the fixed memory area 211, using the shared interface library SI.

In addition, PEI module M23 and the DXE driver D3 also can use their own shared libraries SL.

Accordingly, the shared library SL in the PEI module M23 can be shared between the PEI module M23 and the PEI module M24, and the shared library SL in the DXE driver D3 can be shared between the DXE driver D3 and the DXE driver D4.

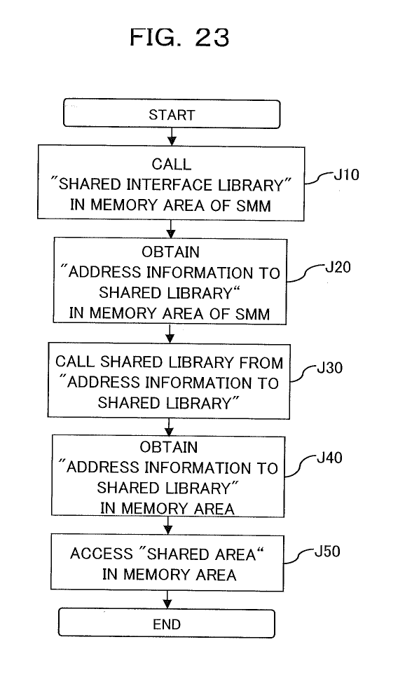

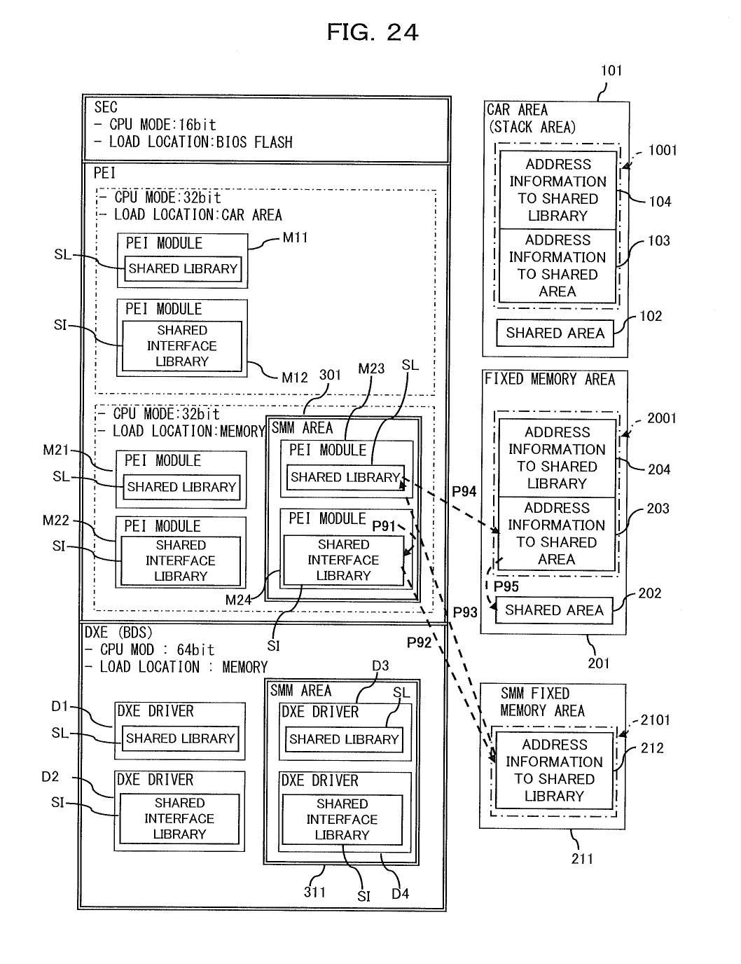

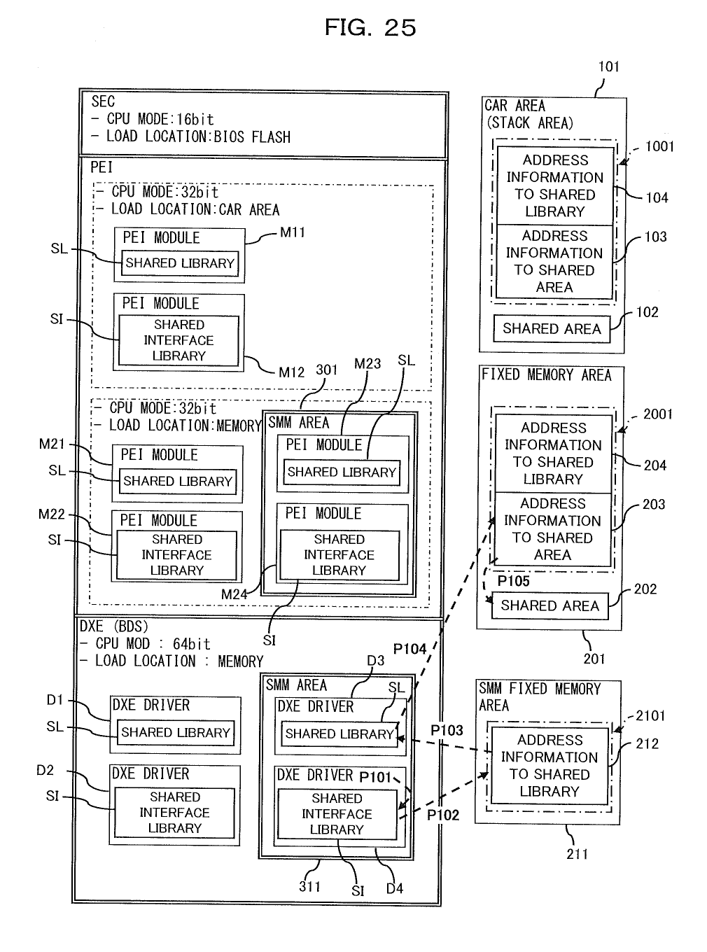

Next, a technique for reading shared area information stored in a shared area 202 in the SMM phase (PEI and DXE) in the information processing apparatus 100 as one example of an embodiment will be described with reference to a flowchart depicted in FIG. 23 (will be described with reference to steps J10 to J50), as well as referring to FIGS. 24 and 25. Note that FIG. 24 is a diagram illustrating a reference path to a shared area in the SMM phase (PEI) in the information processing apparatus 100, while FIG. 25 is a diagram illustrating a reference path to a shared area in the SMM phase (DXE) in the information processing apparatus 100.

In the SMM area, the PEI module M24 (second module) and the DXE driver D4 (second module) call the corresponding shared interface library SI (step J10: see reference symbol P91 in FIG. 24 and reference symbol P101 in FIG. 25), and obtains address information 212 to the shared library in the SMM fixed memory area 211 (step J20: see reference symbol P92 in FIG. 24 and reference symbol P102 in FIG. 25).

The PEI module M24 and the DXE driver D4 call the shared library SL in the PEI module M23 (first module) and the DXE driver D3 (first module) using this address information 212 to the shared library (step J30: see reference symbol P93 in FIG. 24 and reference symbol P103 in FIG. 25).

The PEI module M24 and the DXE driver D4 obtain information to access the address information 203 to the shared area in the shared memory area 201 (for example, a pointer), from this shared library SL, and obtain the address information 203 to the shared area in the fixed memory area 201, based on this information (step J40: see reference symbol P94 in FIG. 24 and reference symbol P104 in FIG. 25). The PEI module M24 and the DXE driver D4 access the shared area 202 in the fixed memory area 201, using this address information 203 to the shared area (step J50: see reference symbol P95 in FIG. 24 and reference symbol P105 in FIG. 25), and obtain the shared area information stored in the shared area 202.

As described above, in the SMM phase (PEI) and the SMM phase (DXE), the PEI module M24 or the DXE driver D4 read the shared library SL in PEI module M23 or the DXE driver D3 via the address information 204 to the shared library in the fixed memory area 201, using the shared interface library SI. Then, they can obtain the address information 203 to the shared area in the fixed memory area 201, using this shared library SL, and obtain the shared area information, using this address information 103 to the shared area.

The PEI module M23 and the DXE driver D3 also can obtain the address information 203 to the shared area in the fixed memory area 201, using its own shared library SL, and obtain the respective shared area information, using this address information 203 to the shared area.

Accordingly, the shared area information in the shared area 202 in the fixed memory area 201 can be shared between the PEI module M23 and the PEI module M24, or between the DXE driver D3 and the DXE driver 1D4.

Note that the PEI module M12, M22, M24 and the DXE drivers D2 and D4 obtain the shared library SL and the shared area information using the shared interface library SI in this embodiment. In other words, it can be regarded that the above-described function as the information obtainment unit 115 is achieved by executing the PEI module M12, M22, M24 and the DXE drivers D2 and D4.

As described above, in accordance with information processing apparatus as one example of an embodiment, the PEI module M11 can use its own shared library SL. On the other hand, the PEI module M12 also can use the shared library SL in the PEI module M11, via the shared interface library SI and the address information to the shared library 104.

In the similar manner, the PEI modules M21 and M23 and the DXE drivers D1 and D3 can use their own shared library SL. On the other hand, the PEI module M22 can use the shared library SL in the PEI module M21, while PEI module M24 can use the shared library SL in the PEI module M23. Furthermore, the DXE driver D2 can use the shared library SL in the DXE driver D3, while the DXE driver D4 can use the shared library SL in the DXE driver D3.

In other words, a module including a shared interface library SI can use shared libraries SL included in other modules, thereby sharing the shared libraries SL. Thereby, the sizes of each module and the program data P can be reduced, and the sizes of the processor cache and the RAM 20 to which the modules are loaded can be reduced, which helps to reduce the size of the BIOS flash 22 to which the program data P is to be stored. Accordingly, increased processing speed and reduction in the manufacturing cost can be achieved.

In addition, the PEI module M11 can use shared area information in the shared area 102 using its own shared library SL. On the other hand, the PEI module M12 can use shared area information in the shared area 102, using the shared interface library SI, the shared library SL, and the address information 103 to the shared area.

In the similar manner, the PEI modules M21 and M23 and the DXE drivers D1 and D3 can use shared area information in the shared area 202 via the address information 203 to the shared area in the fixed memory area 201, using their own shared library SL. On the other hand, the PEI module M22 and the PEI module M24 can use the shared area information in the shared area 202 via the address information 203 to the shared area in the fixed memory area 201, using the shared library SL in the PEI module M21 and the shared library SL in the PEI module M23, respectively. Furthermore, the DXE driver D2 and the DXE driver D4 can use the shared area information in the shared area 202 via the address information 203 to the shared area in the fixed memory area 201, using the shared library SL in the shared library SL and the shared library SL in the DXE driver D3, respectively.

In this manner, a plurality of modules can use the shared area information in the shared area 102 and the shared area 202, thereby sharing the shared area information. Thereby, the sizes of each module and the program data P can be reduced, and the sizes of the processor cache and the RAM 20 to which the modules are loaded can be reduced, which helps to reduce the size of the BIOS flash 22 to which the program data P is to be stored. Accordingly, increased processing speed and reduction in the manufacturing cost can be achieved.

In addition, the shared area 202 for storing shared area information is provided in the fixed memory area 201, and the PEI module M21 to M24 and the DXE driver D1 to D4 can use shared area information in the shared area 202. Thereby, shared area information can be shared among modules of difference phases, i.e., the PEI phase and the DXE phase, which achieves increased processing speed and reduction in the manufacturing cost and enhances convenience.

In addition, since the shared area setting unit 114 copies shared area information stored in the shared area 102 in the CAR area 101 to the shared area 202 in the fixed memory area 201, the shared area information used in the PEI phase (CAR area) can also be used (shared) in the PEI phase (memory area), the DXE phase, the SMM phase (PEI), and the SMM phase (DXE).

The disclosed technique is not limited to the embodiments described above, and various modifications may be made without departing from the spirit of the present embodiments.

For example, although the shared libraries SL are included in the PEI modules M11, M21, and M23 and the DXE drivers D1 and D3 and the shared interface libraries SI are included in the PEI modules M12, M22, and M24 and the DXE drivers D2 and D4, in the embodiment described above, this is not limiting. More specifically, a shared library SL many be provided to any of the modules, and similarly, a shared interface library SI may also be any of the modules. In addition, a single module may include both a shared library SL and a shared interface library SI for making reference to shared libraries SL in other modules, and various modifications may be possible.

In addition, although a shared library SL and shared area information are shared between two modules in each of the PEI phase (CAR area), the PEI phase (memory area), the SMM phase (PEI), and the SMM phase (DXE) in the embodiment described above, this is not limiting. In other words, three or more modules can share a shared library SL or shared area information, and the number of sharing modules can be modified appropriately.

Furthermore, although the CPU 10 is provided as a processor and various functions as the startup processing unit 11 are embodied in the CPU 10 in the embodiment described above, this is not limiting. For example, other processors, such as a micro-processing unit (MPU), may be used.

The embodiments may be practiced or manufactured by those ordinally skilled in the art with reference to the above disclosure.

In accordance with the disclosed technique, since first shared information included in a first module can be obtained and used by a second module during startup processing of an information processing apparatus, the first shared information can be shared among a plurality of modules. Thereby, the sizes of a module and a program related to the startup processing of the information processing apparatus can be reduced, which helps to reduce the sizes of a memory or a BIOS flash to which they are loaded. Accordingly, increased processing speed and reduction in the manufacturing cost can be achieved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A method for startup processing of an information processing apparatus including a processor, the method including:
loading a first module among a plurality of modules embodying a part of the startup process of the information processing apparatus when executed by the processor, the first module including first shared information commonly used by two or more of the plurality of modules;
storing access information for accessing the first shared information to a storage area provided in the information processing apparatus;
loading a second module including interface information for accessing the access information; and
accessing the access information by the second module using the interface information and obtaining the first shared information via the access information.

2. The method of startup processing according to claim 1, further including:
creating a shared area in the storage area for storing second shared information commonly used by two or more of the plurality of modules;
storing shared area access information for accessing the shared area, in the storage area; and
accessing the access information by the second module using the interface information, accessing the first shared information using the access information that is accessed, accessing the shared area access information based on the first shared information that is accessed, and obtaining the second shared information stored in the shared area, using the shared area access information that is accessed.

3. The method of startup processing according to claim 2, wherein the startup processing includes a plurality of phases,
wherein the method further includes:
using a processor cache of the processor as the storage area in one of the plurality of phases, and
after a main storage apparatus of the information processing apparatus is made available, duplicating the second shared information stored in the processor cache to the main storage apparatus.

4. An information processing apparatus including:
a processor;
a first module setting unit that loads, during startup process, a first module among a plurality of modules embodying a part of the startup process of the information processing apparatus when executed by the processor, the first module including first shared information commonly used by two or more of the plurality of modules;
an assess information setting units that stores, during the startup process, access information for accessing the first shared information to a storage area provided in the information processing apparatus;
a second module setting unit that loads, during the startup process, a second module including interface information for accessing the access information; and
a first obtainment unit that accesses, during the startup process, the access information by the second module using the interface information and obtaining the first shared information via the access information.

5. The information processing apparatus according to claim 4, further including:
a shared area setting unit that creates, during the startup process, a shared area in the storage area for storing second shared information commonly used by two or more of the plurality of modules;
a shared area access information setting unit that stores, during the startup process, shared area access information for accessing the shared area, in the storage area; and
a second information obtainment unit that accesses, during the startup process, the access information by the second module using the interface information, accesses the first shared information using the access information that is accessed, accesses the shared area access information based on the first shared information that is accessed, and obtains the second shared information stored in the shared area, using the shared area access information that is accessed.

6. The information processing apparatus according to claim 5, wherein the startup processing includes a plurality of phases,
a processor cache of the processor is used as the storage area in one of the plurality of phases, and
the shared area setting unit, after a main storage apparatus of the information processing apparatus is made available, duplicates the second shared information stored in the processor cache to the main storage apparatus.

7. A computer-readable non-transitory recording medium having a startup processing program stored thereon for making the compute execute startup processing,
the startup processing program making the computer:
load a first module among a plurality of modules embodying a part of the startup process of the information processing apparatus when executed by the computer, the first module including first shared information commonly used by two or more of the plurality of modules;
store access information for accessing the first shared information to a storage area provided in the information processing apparatus;
load a second module including interface information for accessing the access information; and
access the access information by the second module using the interface information and obtaining the first shared information via the access information.

8. The computer readable recording medium according to claim 7 having a startup processing program recorded thereon, wherein the startup processing program makes the computer to:
create a shared area in the storage area for storing second shared information commonly used by two or more of the plurality of modules;
store, in the storage area, shared area access information for accessing the shared area; and
access the access information by the second module using the interface information, access the first shared information using the access information that is accessed, access the shared area access information based on the first shared information that is accessed, and obtain the second shared information stored in the shared area, using the shared area access information that is accessed.

9. The computer readable recording medium according to claim 7 having a startup processing program recorded thereon, wherein the startup processing includes a plurality of phases, and
the startup processing program makes the computer to:
use a processor cache of the processor is used as the storage area in one of the plurality of phases, and
after a main storage apparatus of the information processing apparatus is made available, duplicate the second shared information stored in the processor cache to the main storage apparatus.
